(19) United States
(12) Patent Application Publication
(10) Pub. No.: US 2009/0036056 A1
(43) Pub. Date: Feb. 5, 2009

(54) INFORMATION PROCESSING SYSTEM, INFORMATION PROCESSING DEVICE, AND INFORMATION PROCESSING METHOD

(75) Inventors: Yukiko Oshima, Tokyo (JP); Yoshinaga Kato, Kanagawa (JP)

Correspondence Address: COOPER & DUNHAM, LLP, 30 Rockefeller Plaza, 20th Floor, NEW YORK, NY, 10112, US

(73) Assignee: RICOH COMPANY, LTD,, Tokyo (JP)

(21) Appl. No.: 12/181,817

(22) Filed: Jul. 29, 2008

(30) Foreign Application Priority Data
Aug. 3, 2007 (JP) 2007-203573

(51) Int. Cl. H04B 7/00

(52) U.S. Cl. 455/41.3

(57) ABSTRACT

A portable terminal device includes a first communication unit that transmits communication setting information and function information to an information processing device in non-contact communication, an input receiving unit that receives an input of the communication setting information and the function information, and a second communication unit that transmits entity information to the information processing device or receives entity information from the information processing device in non-contact communication.

### CROSS-REFERENCE TO RELATED APPLICATIONS

The present application claims priority to and incorporates by reference the entire contents of Japanese priority document 2007-203573 filed in Japan on Aug. 3, 2007.

### BACKGROUND OF THE INVENTION

1. Field of the Invention

The present invention relates to an information processing system, an information processing device, and an information processing method.

2. Description of the Related Art

In recent years, with business machines such as a printing device, plural office devices are connected to a network, and a document can be printed by assigning a desired printing device from a client terminal such as a personal computer (PC) connected to the network.

This configuration also applies to a multi function machine called a multi function peripheral (MFP) that includes a copy function, facsimile (FAX) function, printer function, and scanner function incorporated in one casing. The MFP can print documents by also assigning various kinds of setting information including necessity of stapling, necessity of punching, or the like.

For example, according to Japanese Patent Application Laid-open No. 2006-173948, a client terminal receives by beacon, connection setting information necessary to perform an ad-hock communication with an image forming apparatus via a wireless local area network (LAN), and function information (such as color or monochromatic, whether both-side printing is possible, printable paper size, or the like) that the image forming apparatus can set. A user can set preferable function information by referencing the received beacon, and print a document and the like from a desired image forming apparatus.

Further, according to Japanese Patent Application Laid-open No. 2004-200887, by using a non-contact IC (Integrated Circuit) tag, an intermediary terminal is brought close to a device to be connected, and a user can naturally establish a connection of a device that can print a document or the like.

However, according to the technique described in Japanese Patent Application Laid-open No. 2006-173948, while the user can determine that a printable image forming apparatus is at a relatively near distance when the client terminal receives the beacon, the user cannot naturally determine visually where the image forming apparatus is actually present. Therefore, even when the printable image forming apparatus is set in front, the user needs to confirm the connection setting information or the like.

Further, according to the technique described Japanese Patent Application Laid-open No. 2004-200887, because the intermediary terminal transmits only the connection setting information to the close device, the user cannot assign function information (such as color or monochromatic, whether both-side printing is possible, printable paper size, or the like) based on which the print is performed.

### SUMMARY OF THE INVENTION

It is an object of the present invention to at least partially solve the problems in the conventional technology.

According to an aspect of the present invention, there is provided an information processing system including a portable terminal device including a first communication unit and a second communication unit of mutually different communication ranges, and an information processing device including a third communication unit having the same communication method as that of the first communication unit and a fourth communication unit having the same communication method as that of the second communication unit, the portable terminal device and the information processing unit communicating with each other in non-contact communication using the first communication unit and the third communication unit, and the portable terminal device and the information processing unit communicating with each other in non-contact communication using the second communication unit and the fourth communication unit. The portable terminal device includes a first communication control unit that transmits communication setting information to establish communication between the second communication unit and the fourth communication unit, and first function information showing a process to predetermined information to be received or transmitted by the second communication unit, to the information processing device in non-contact communication via the first communication unit, when the portable terminal device approaches a communication range of the information processing device; an input receiving unit that receives an input of the communication setting information and the first function information; and a second communication control unit that establishes communication with the information processing device, and transmits predetermined information to the information processing device or receives predetermined information from the information processing device, in non-contact communication via the second communication unit. The information processing device includes a third communication control unit that receives the communication setting information and the first function information from the portable terminal device in non-contact, via the third communication unit, when the portable terminal device approaches the communication range of the information processing device; a fourth communication control unit that establishes communication with the portable terminal device based on the communication setting information received by the third communication control unit, and receives predetermined information from the portable terminal device or transmits predetermined information to the portable terminal device in non-contact communication; and a processing unit that processes the predetermined information corresponding to the first function information received by the fourth communication control unit.

According to another aspect of the present invention, there is provided an information processing device including a first communication unit and a second communication unit that communicate with a portable terminal device in non-contact communication, and have mutually different communication ranges. The information processing unit further includes a first communication control unit that receives from the portable terminal device in non-contact communication, communication setting information to establish communication of the second communication unit and function information showing a function to process predetermined information to be received or transmitted by the second communication unit, when the portable terminal device approaches a communication range of the information processing device; a second communication control unit that establishes communication with the portable terminal device based on the communication setting information received by the first communication control unit, and that receives predetermined information from the portable terminal device or transmits predetermined information to the portable terminal device in non-contact communication; and a processing unit that processes the predetermined information by function corresponding to the function information received by the second communication control unit.

According to still another aspect of the present invention, there is provided an information processing method realized on an information processing device including a first communication unit and a second communication unit that communicate with a portable terminal device in non-contact communication, and have mutually different communication ranges. The information processing method includes performing first communication control including receiving from the portable terminal device in non-contact communication, communication setting information to establish communication of the second communication unit and function information showing a function to process predetermined information to be received or transmitted by the second communication unit, when the portable terminal device approaches a communication range of the information processing device; performing second communication control including establishing communication with the portable terminal device based on the communication setting information received at the performing first communication control, and receiving predetermined information from the portable terminal device or transmitting predetermined information to the portable terminal device in non-contact communication; and processing the predetermined information by function corresponding to the function information received at the performing second communication control.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of a configuration of an information processing system according to a first embodiment of the present invention;

FIG. 2 is a functional block diagram of a configuration of the information processing system according to the first embodiment;

FIG. 3 depicts an example of a data configuration of an authentication-data memory unit shown in FIG. 1;

FIG. 4 depicts an example of a data configuration of a data memory unit shown in FIG. 1;

FIG. 5 is a schematic diagram for explaining one example of a display screen displayed by an operation display unit shown in FIG. 1;

FIG. 6 is a flowchart of a radio-communication-establishment process procedure and a data processing procedure performed by the information processing system according to the first embodiment;

FIG. 7 is a schematic diagram for explaining a hardware configuration of a multi function peripheral shown in FIG. 1;

FIG. 8 is a schematic diagram of a configuration of an information processing system according to a second embodiment of the present invention;

FIG. 9 is a functional block diagram of a configuration of the information processing system according to the second embodiment;

FIG. 10 is a flowchart of a radio-communication-establishment process procedure and a setting-candidate-data-transmission process procedure performed by the information processing system according to the second embodiment;

FIG. 11 is a schematic diagram of a configuration of a car navigation system according to a third embodiment of the present invention;

FIG. 12 is a schematic diagram of a configuration of a slideshow system according to a fourth embodiment of the present invention;

FIG. 13 is a schematic diagram of a configuration of an information processing system according to a fifth embodiment of the present invention;

FIG. 14 is a functional block diagram of a configuration of the information processing system according to the fifth embodiment;

FIG. 15 is a schematic diagram of a configuration of an information processing system according to a sixth embodiment of the present invention; and

FIG. 16 is a functional block diagram of a configuration of the information processing system according to the sixth embodiment.

### DETAILED DESCRIPTION OF THE PREFERRED EMBODIMENTS

Exemplary embodiments of the present invention will be explained below in detail with reference to the accompanying drawings. The present invention is not limited to the embodiments.

A first embodiment of the present invention is explained with reference to the accompanying drawings. The first embodiment is applied to so-called a multi function peripheral (MFP) which includes a copy function, FAX function, printer function, a scanner function, and a function of distributing input image data (image data read by the scanner function, image data formed by the printer function, and image data received by the FAX function), as one example of an information processing device. While the present invention is explained as being applied to the multi functional peripheral as one example of the information processing device, the present invention can be also applied to an information processing device such as a printing device having only the printer function, a scanner device having only the scanner function, and an image forming apparatus having these functions, and the application is not limited to the MFP.

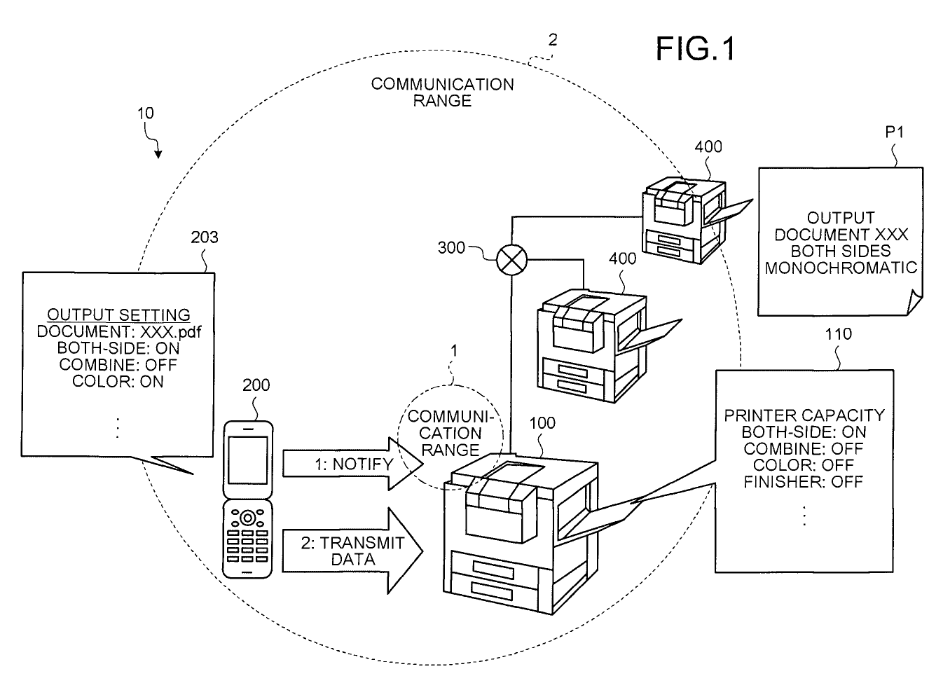

First, a configuration example of an information processing system including a multi function peripheral and a portable terminal device to which the present invention is applied is explained. FIG. 1 is a schematic diagram of a configuration of an information processing system 10 according to the first embodiment. The information processing system 10 includes a multifunction peripheral (MFP) 100, and a portable terminal device 200. The MFP 100 and the portable terminal device 200 can communicate with each other using two communication units as described later, within a communication range 1 indicated by a broken line and a communication range 2 indicated by a chain double-dashed line. The MFP 100 is connected to a network 300, and is also connected to another MFP 400, a facsimile device, and a client terminal device, via the network 300. In the portable terminal device 200, a user can set “both-side” printing to “on”, set “combine” to “off”, and set “color” printing to “on”, for data of document data “XXX.pdf”, as an output setting to the MFP 100. On the other hand, the user can set “both-side” printing to “on”, set “combine” to “off”, and set “color” printing to “off”, as capability of the printer function of the MFP 100. In the subsequent printing process, document data P1 shown in FIG. 1 is monochromatic, and is output as a document of both-side printing without combining.

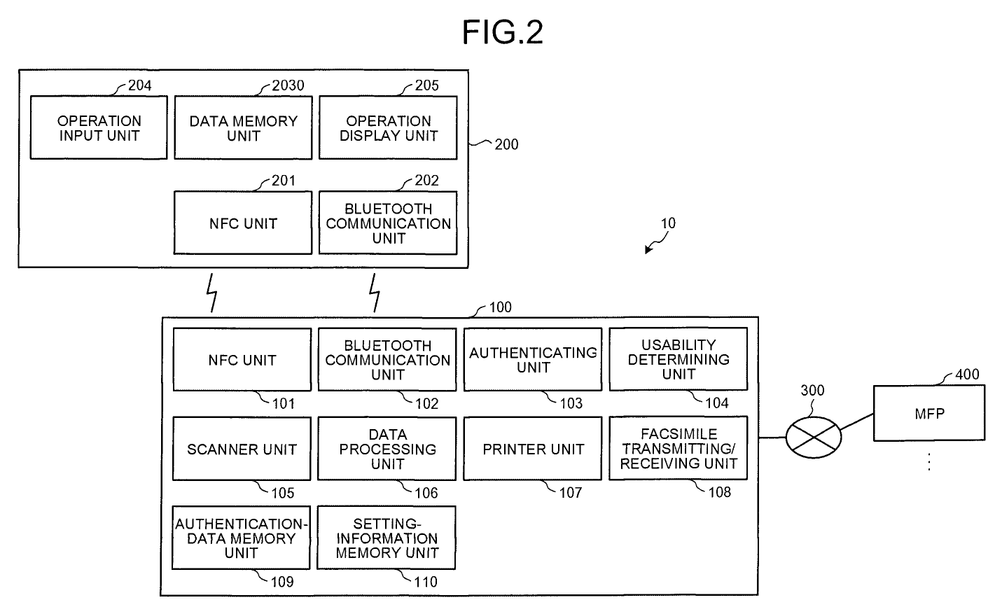

FIG. 2 is a functional block diagram of a configuration of the information processing system 10. The MFP 100 includes a near field communication (NFC) unit 101, a Bluetooth communication unit 102, an authenticating unit 103, a usability determining unit 104, a scanner unit 105, a data processing unit 106, a printer unit 107, a facsimile transmitting/receiving unit 108, an authentication-data memory unit 109, and a setting-information memory unit 110.

The NFC unit 101 communicates in a non-contact manner with the portable terminal device 200 based on a non-contact-IC-radio communication standard called NFC. Specifically, the NFC unit 101 is a reader/writer incorporating a communication control program for reading in non-contact, information from a tag of an NFC unit 201 of the portable terminal device described later. The NFC unit 101 transmits and receives data by non-contact radio communication of a closer distance than that of the Bluetooth communication unit 102 as another communication unit, that is, in a communication distance of about zero to a few millimeters. In the non-contact communication of the NFC standard by the NFC unit 101, a data transfer speed (100 kilobits per seconds (kbps) to 400 kbps) is slower than a data transfer speed (1 megabits per second (Mbps) to 2 Mbps) of radio communication of the Bluetooth standard by the Bluetooth communication unit 102. Therefore, the non-contact communication of the NFC standard by the NFC unit 101 is used for data communication of a relatively small capacity. The communication standard of the NFC unit 101 does not need to be limited to NFC, and other communication standard can be used, when communication is possible in a relatively short distance, that is, within a communication range narrower than that of the radio communication of the Bluetooth standard described later. The NFC unit 101 constitutes a first communication unit.

The NFC unit 101 establishes communication with the NFC unit 201 of the portable terminal device 200 when the portable terminal device 200 comes close to the communication range of the NFC unit 101, and receives an authentication identification (ID), a function ID, communication setting information, and function setting information. The authentication ID is the information to determine whether use of the MFP 100 based on the instruction from the portable terminal device 200 is permitted (authentication). The authentication ID can be also intrinsic information allocated to the portable terminal device 200, or information to identify a user having the portable terminal device 200. When the information to identify a user is used, information such as a company member ID can be used. The function ID is the information showing the function of the MFP 100 of which use the portable terminal device 200 requests (function information). For example, when the printer function of the MFP 100 is used, a “printer ID” is set as the function ID. When the scanner function of the MFP 100 is used, a “scanner ID” is set as the function ID.

The communication setting information is the information necessary to perform radio communication by the Bluetooth communication unit 102. By receiving the communication setting information of the Bluetooth communication between the portable terminal device 200 and the MFP 100 by the NFC communication in which data transmission and reception is easy, the user can specify the MFP 100 as the communication party, and can perform the Bluetooth communication, without performing a special operation, by only bringing the portable terminal device 200 to the MFP 100. Therefore, convenience increases. The function setting information is the setting information to indicate a processing content corresponding to the function. For example, when the printer ID is set as the function ID, the setting value “on” or “off” is set to the setting ID “both-side print” as the print setting information, and the setting value “on” or “off” is set to the setting ID “combine”, as the function setting information. When the scan ID is set as the function ID, a setting value of “300” dots per second (dps) or the like is set to a setting ID “resolution” as the scan setting information, as the function setting information.

The authenticating unit 103 determines whether the authentication ID transmitted from the portable terminal device 200 is the ID that is permitted to use the MFP 100. Specifically, the authenticating unit 103 authenticates the use based on whether the authentication ID received by the NFC unit 101 coincides with the authentication ID stored in the authentication-data memory unit 109.

The usability determining unit 104 determines whether the function ID transmitted by the portable terminal device 200 is the ID that is permitted to be used in the MFP 100. Specifically, the usability determining unit 104 obtains the authentication ID and use permission information corresponding to the function ID that the NFC unit 101 receives from the authentication-data memory unit 109, and determines the use based on whether usability is set to the obtained use permission information.

The Bluetooth communication unit 102 communicates with the portable terminal device 200 in non-contact based on the Bluetooth (registered trademark) standard. The Bluetooth communication unit 102 employing the radio communication system of the Bluetooth standard performs data transmission and reception in a larger capacity at a higher speed (1 Mbps to 2 Mbps) than those of the NFC unit 101 of the non-contact communication system of the NFC standard. The Bluetooth communication unit 102 employing the radio communication system of the Bluetooth standard can be used even if a barrier is present, when the distance between the devices is within 10 meters. The Bluetooth communication unit 102 has a longer communication range than the communication range of the communication system of the NFC standard.

The Bluetooth communication unit 102 specifically includes a Bluetooth interface (I/F) such as a transceiver of the Bluetooth standard for performing data transmission and reception, and a communication control unit. The Bluetooth I/F performs data transmission and reception with the connected portable terminal device 200. The communication control unit is a communication control program that performs a process of establishing radio communication of the Bluetooth standard, by exchanging communication setting information with the communication destination via the I/F, before performing the data transmission and reception with the portable terminal device 200. For the communication setting information, intrinsic address information allocated to the I/F is used.

In the first embodiment, while the Bluetooth communication unit 102 based on the Bluetooth standard is used for radio communication, the standard is not limited. The Bluetooth communication unit can be also configured to perform radio communication using a wireless fidelity (WiFi) system of the IEEE (the Institute of Electrical and Electronics Engineers) 802.11a/IEEE 802.11b standard, instead of the Bluetooth standard. In this case, the WiFi communication unit is configured by a network keyboard of the IEEE 802.11a/IEEE 802.11b standard that performs data transmission and reception, and a communication control unit (communication control program) that establishes radio communication based on the IEEE 802.11a/IEEE 802.11b standard and controls the data transmission and reception. When a distance between the devices is within 3 meters in the ultra wideband (UWB) communication system, the WiFi communication unit can be configured to perform radio communication in the Wireless universal serial bus (USB) standard capable of performing communication at 480 Mbps equivalent to that of the wired USB2.0. In this case, the Wireless USB communication unit is configured by the USB device of the Wireless USB standard that performs data transmission and reception and the UWB communication system, and a communication control unit (communication control program) that establishes radio communication based on the USB system and controls the data transmission and reception.

The Bluetooth communication unit 102 receives the communication setting information from the portable terminal device 200 by the NFC communication. When Bluetooth communication with the portable terminal device 200 is established by the received communication setting information, the Bluetooth communication unit 102 transmits and receives data corresponding to the function ID. The transmitted and received data can be any kind of data such as image data, document data, text data, or the like.

The scanner unit 105 reads a document with an imaging element such as a charge coupled device (CCD). The scanner unit 105 can be mounted with an auto document feeder (ADF) to automatically transmit the document.

The data processing unit 106 performs a process corresponding to the function ID and the function setting condition received by the NFC unit 101, to the data received by the Bluetooth communication unit 102 or the data transmitted by the Bluetooth communication unit 102. For example, when the function ID is a “printer ID”, the data processing unit 106 performs an image process such as concentration and color adjustment and a layout process such as a one-side/both-side printing, to the data corresponding to the function setting information. When the function ID is a “scanner ID”, the data processing unit 106 performs an image process and a layout process following the function setting condition, to the data read from the scanner unit 105.

The printer unit 107 prints the data that is image-processed and layout-processed by the data processing unit 106.

The facsimile transmitting/receiving unit 108 transmits data read by the scanner unit 105 and data transmitted from the portable terminal device 200, to the MFP 400, the facsimile device, and the client terminal via the network 300. The facsimile transmitting/receiving unit 108 also receives data transmitted from the MFP 400, the facsimile device, and the client terminal.

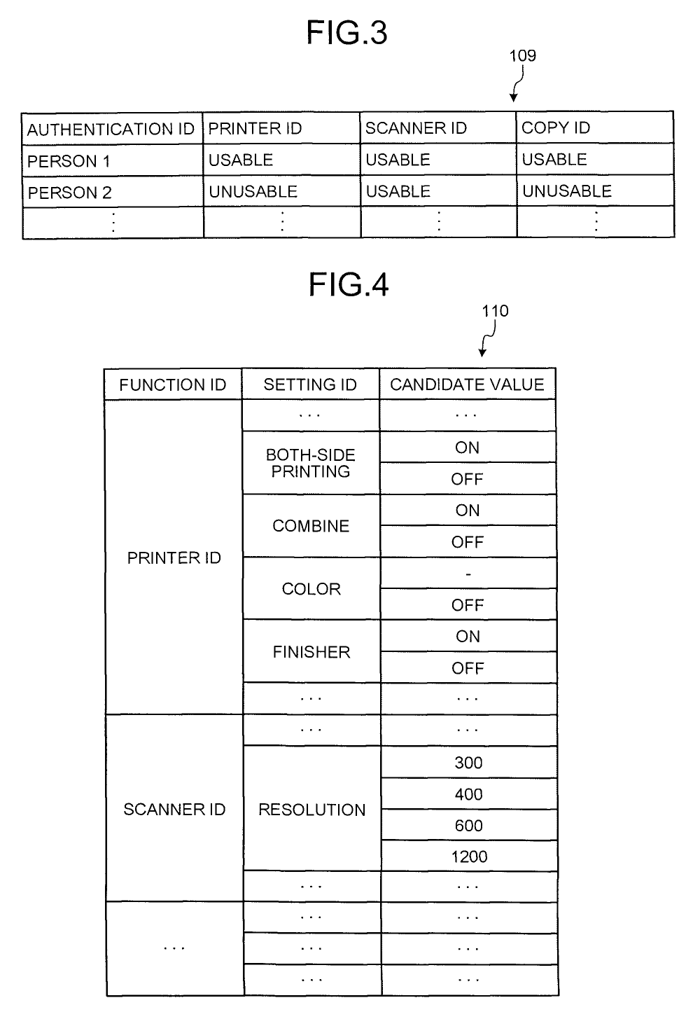

The authentication-data memory unit 109 stores therein authentication data for determining whether the MFP 100 or the function of the MFP 100 are authentic devices. FIG. 3 depicts an example of a data configuration of the authentication-data memory unit 109. The authentication-data memory unit 109 stores therein authentication IDs and use permission data for each function ID, by relating to each other. As shown in FIG. 3, an authentication ID “person1” can use all of the printer function, the scanner function, and the copy function of the MFP 100. An authentication ID “person2” can use the scanner function of the MFP 100, but cannot use the printer function and the copy function.

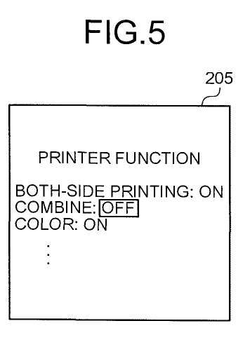

The setting-information memory unit 110 stores therein the function held by the MFP 100 by relating the function to the function ID, the setting ID, and a candidate value, as the function setting information, as shown in FIG. 4. For example, in the setting of both-side printing of the printer function, “on” or “off” can be set, but in the setting of color print, only “off” can be set. That is, this shows that only monochromatic printing is possible. As explained above, because the MFP 100 has different processing content for each function depending on a type of machine in general, the setting ID for each function ID and a settable candidate value corresponding to the setting ID are stored.

Next, the portable terminal device 200 is explained. The portable terminal device 200 includes the NFC unit 201, a Bluetooth communication unit 202, and a data memory unit 203. The portable terminal device 200 specifically includes a portable telephone, personal digital assistant (PDF), a notebook PC, a portable memory medium, or the like.

The NFC unit 201 establishes communication with the NFC unit 101 of the MFP 100 when the portable terminal device 200 comes close to the communication range of the NFC unit 101 of the MFP 100. The NFC unit 201 transmits the authentication ID and the function ID for the portable terminal device 200 to use the MFP 100, and communication setting information and function setting information for the Bluetooth communication unit 202 to establish communication.

Specifically, the NFC unit 201 is an NFC chip incorporating a tag, and a communication control program for controlling communication establishment and transmission and reception of data. This tag stores therein the above authentication ID and the function ID. When the NFC unit 201 is brought close to the MFP 100, communication is established, and the NFC unit (reader/writer) 101 of the MFP 100 reads and transmits the information stored in the tag.

In this case, the NFC unit 201 can be configured to transmit the authentication ID and the function ID to the MFP 100, independently of the body of the portable terminal device 200, by storing the NFC chip incorporating the tag and the communication control program in a non-contact IC card.

In the first embodiment, the NFC unit 101 of the MFP 100 is configured as the reader/writer, by providing a tag storing the authentication ID and the function ID in the NFC unit 201 of the portable terminal device 200. However, the configuration is not limited to the above. The NFC unit 201 of the portable terminal device 200 can be configured as the reader/writer, and the NFC unit 101 of the MFP 100 can be configured as the tag. In this case, the following configuration can be provided. The authentication ID and the function ID are stored in the data memory unit 203 of the portable terminal device 200. The NFC unit 201 is brought close to the MFP 100 to establish communication. A control unit (not shown) transfers the authentication ID and the function ID of the data memory unit 203 to the NFC unit 201. The reader/writer of the NFC unit 201 transmits and writes the transferred authentication ID and the function ID, into the NFC unit (tag) 101 of the MFP 100.

When communication with the Bluetooth communication unit 102 of the MFP 100 is established, the Bluetooth communication unit 202 transmits data stored in the data memory unit 203 to the MFP 100. The Bluetooth communication unit 202 also receives data processed using the function of the MFP 100.

The data memory unit 203 stores therein data to use the function of the MFP 100. For example, when the printer function of the MFP 100 is used, the communication setting information, the print setting information as the function setting information, and the image data are stored. The function setting information is stored in the data format of “setting ID: setting value”, for example. The setting ID is the information showing the processing content of the function. For example, in the case of the printer function, “both-side printing” and the like are available for the setting ID. The setting value is the value set as a process to data from candidate values that can be set to the setting ID. The setting value “on” or the like is set to the setting ID “both-side printing”.

An operation input unit 204 includes an operation button such as a push button, and receives the input of a function ID, a setting ID, and a candidate value from the user. For example, at the time of selectively assigning a candidate value to use the MFP 100 stored in the data memory unit 203, the user depresses the operation input unit 204 to assign “on” or “off”.

An operation display unit 205 includes a screen of a liquid-crystal display or the like, and displays the communication setting information and the function setting information stored in the data memory unit 203. For example, the operation display unit 205 displays a setting ID and candidate values corresponding to the function ID stored in the data memory unit 203. The user depresses the operation input unit 204 from among the displayed candidate values corresponding to the setting ID. FIG. 5 is a schematic diagram for explaining one example of a display screen displayed by the operation display unit. As shown in FIG. 5, “both-side printing” and “combine” are displayed as the setting IDs of the printer function, and candidate values are displayed, respectively. A candidate value, that is, a setting value, selected by the operation display unit 205 is encircled by a frame.

In the first embodiment, it is explained that the portable terminal device 200 includes both the NFC unit 201 and the Bluetooth communication unit 202. Further, two portable terminal devices can include the NFC unit 201 and the Bluetooth communication unit 202, respectively, and the two portable terminal devices can establish communication to transmit and receive data, respectively. For example, one portable terminal device including the NFC unit 201 stores a function ID, communication setting information, and function setting information, and transmits data to the NFC unit 101 of the MFP 100. The other portable terminal device including the Bluetooth communication unit 202 transmits data to the MFP 100 using the communication setting information transmitted earlier. With this arrangement, the function of the MFP 100 can be used easily.

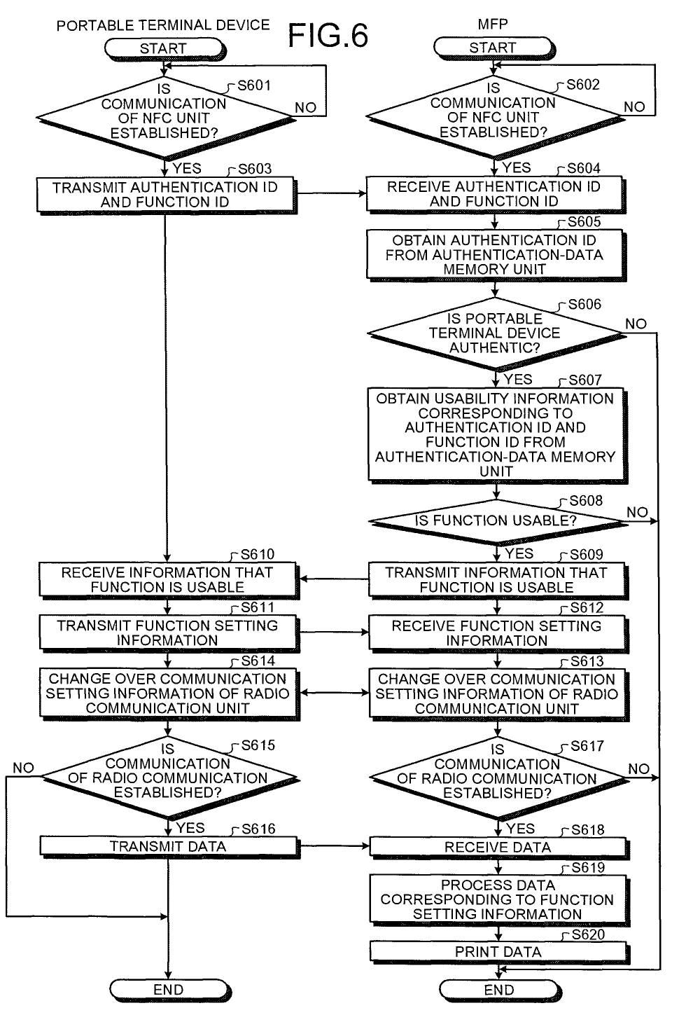

A radio communication establishment and a data process performed by the information processing system 10 that includes the MFP 100 and the portable terminal device 200 having the above configuration is explained next. FIG. 6 is a flowchart of a radio-communication-establishment process procedure and a data processing procedure performed by the information processing system 10.

First, in the portable terminal device 200, the NFC unit 201 determines whether communication with the NFC unit 101 of the MFP 100 has been established (step S601). When it is determined that communication with the NFC unit 101 of the MFP 100 has not been established, that is, the portable terminal device 200 is not present within the communication range (NO at step S601), the process control is returned to step S601, and this step is repeated until when communication with the NFC unit 101 of the MFP 100 is established.

Similarly, in the MFP 100, the NFC unit 101 determines whether communication with the NFC unit 201 of the portable terminal device 200 has been established (step S602). When it is determined that communication with the NFC unit 201 of the portable terminal device 200 has not been established, that is, the portable terminal device 200 is not present within the communication range (NO at step S602), the process control is returned to step S602, and this step is repeated until when communication with the NFC unit 201 of the portable terminal device 200 is established.

Next, when it is determined that communication with the NFC unit 201 of the portable terminal device 200 has been established, that is, the portable terminal device 200 is present within the communication range (YES at step S601), the NFC unit 201 transmits the authentication ID and the function ID to the NFC unit 101 of the MFP 100 (step S603). In this case, that the portable terminal device 200 is present within the communication range mean the time when the user can make the NFC unit 201 of the portable terminal device 200 touch the NFC unit 101 of the MFP 100, and the user can securely instruct the MFP 100 to be used.

When the MFP 100 determines that communication with the NFC unit 201 of the portable terminal device 200 has been established, that is, the portable terminal device 200 is present within the communication range (YES at step S602), the NFC unit 101 receives the authentication ID and the function ID transmitted from the NFC unit 201 of the portable terminal device 200 (step S604). The authenticating unit 103 obtains the authentication ID from the authentication-data memory unit 109 (step S605). The authenticating unit 103 compares the authentication ID obtained from the authentication-data memory unit 109 with the authentication ID transmitted from the portable terminal device 200, and determines whether the portable terminal device 200 is an authentic device (step S606). When it is determined that the portable terminal device 200 is not authentic, that is, the received authentication ID does not match with an authentication ID stored beforehand in the authentication-data memory unit 109 (NO at step S606), the process ends.

When it is determined that the authentication ID is an authentic device, that is, when the received authentication ID matches with an authentication ID stored beforehand in the authentication-data memory unit 109 (YES at step S606), the MFP 100 obtains, from the authentication-data memory unit 109, usability information corresponding to the authentication ID and the function ID that the usability determining unit 104 receives from the portable terminal device 200 (step S607). The usability determining unit 104 determines whether the assigned function can be used (step S608). When it is determined that the assigned function cannot be used (NO at step S608), the process ends.

When it is determined that the assigned function can be used (YES at step S608), the NFC unit 101 transmits the information that the assigned function can be used, to the portable terminal device 200 (step S609), and the NFC unit 201 receives information that the assigned function can be used, from the MFP 100 (step S610).

Upon receiving the information that the assigned function can be used from the MFP 100, the NFC unit 201 transmits function setting information to the NFC unit 101 of the MFP 100 (step S611), and the NFC unit 101 receives the function setting information from the portable terminal device 200 (step S612).

The NFC unit 101 then exchanges communication setting information with the portable terminal device 200 (steps S613 and S614). Specifically, the NFC unit 101 of the MFP 100 transmits the communication setting information to the portable terminal device 200, and the NFC unit 201 of the portable terminal device 200 transmits the communication setting information of Bluetooth communication. The communication setting information of Bluetooth communication can be transmitted together with the authentication ID and the function ID at steps S603 and S604, or can be transmitted together with the function setting information at steps S611 and S612.

In the portable terminal device 200, the Bluetooth communication unit 202 determines whether communication with the Bluetooth communication unit 102 of the MFP 100 has been established (step S615). When it is determined that communication with the Bluetooth communication unit 102 of the MFP 100 has not been established (NO at step S615), the process ends. When it is determined that communication with the Bluetooth communication unit 102 of the MFP 100 has been established (YES at step S615), the Bluetooth communication unit 202 transmits the data stored in the data memory unit 203 to the MFP 100 (step S616).

On the other hand, in the MFP 100, the Bluetooth communication unit 102 determines whether communication with the Bluetooth communication unit 202 of the portable terminal device 200 has been established (step S617). When it is determined that communication with the Bluetooth communication unit 202 of the portable terminal device 200 has not been established (NO at step S617), the process ends.

When it is determined that communication with the Bluetooth communication unit 202 of the portable terminal device 200 has been established (YES at step S617), the Bluetooth communication unit 102 receives the data transmitted from the portable terminal device 200 (step S618). The data to be received is the data before being processed following the print setting information. When the portable terminal device 200 has the data processing function, the portable terminal device 200 can receive the processed data and print the received data. Alternatively, the portable terminal device 200 can receive data corresponding to a part of the print setting information, and the MFP 100 can process the remaining data following the print setting information transmitted from the portable terminal device 200. The data processing unit 106 prints the received data for printing, following the print setting information (step S619). The processing of data can be performed by the printer driver, or embedding the print setting information into the data in each description language format such as portable document format (PDF) or PostScript. The printer unit 107 prints the processed data (step S620).

As explained above, the portable terminal device 200 and the MFP 100 can transmit communication setting information necessary for the Bluetooth communication in the NFC communication, and establish the Bluetooth communication using the transmitted communication setting information. Therefore, the user can naturally assign a device, can set function information concerning the assigned device, and perform a printing process in the device.

FIG. 1 is an example where the user performs a printing process from the portable terminal device 200 to the MFP 100, based on the procedure described above. In FIG. 1, the user sets both-side printing to “on”, combine to “off”, and set color to “on”, as the function setting information set in the data memory unit 203 of the portable terminal device 200. As the functions of the MFP 100, both-side printing is set to “on”, combine is set to “off”, and color is set to “off”, in the setting-information memory unit 110. In this case, while the user sets color “on” in the portable terminal device 200, the document P1 finally printed by the MFP 100 is monochromatic printing on both sides, because the function of the MFP 100 is set such that color is only “off”, that is, only monochromatic printing.

In the first embodiment, while the printer function is explained as one example of the function used in the MFP 100, other function that can be used in the MFP 100, such as the FAX function, can be also used. For example, when the FAX function is used, data stored in the data memory unit 203 of the portable terminal device 200 can be transmitted to the MFP 100, and the data can be transmitted to the MFP 400 or other facsimile device following the function setting information.

When the copy function is used, the copy ID and the copy setting information can be transmitted to the MFP 100, as the function IDs stored in the data memory unit 203 of the portable terminal device 200. The scanner unit 105 can read the document, and performs data processing to the read data, following the copy setting information, and the printer unit 107 can print the processed data.

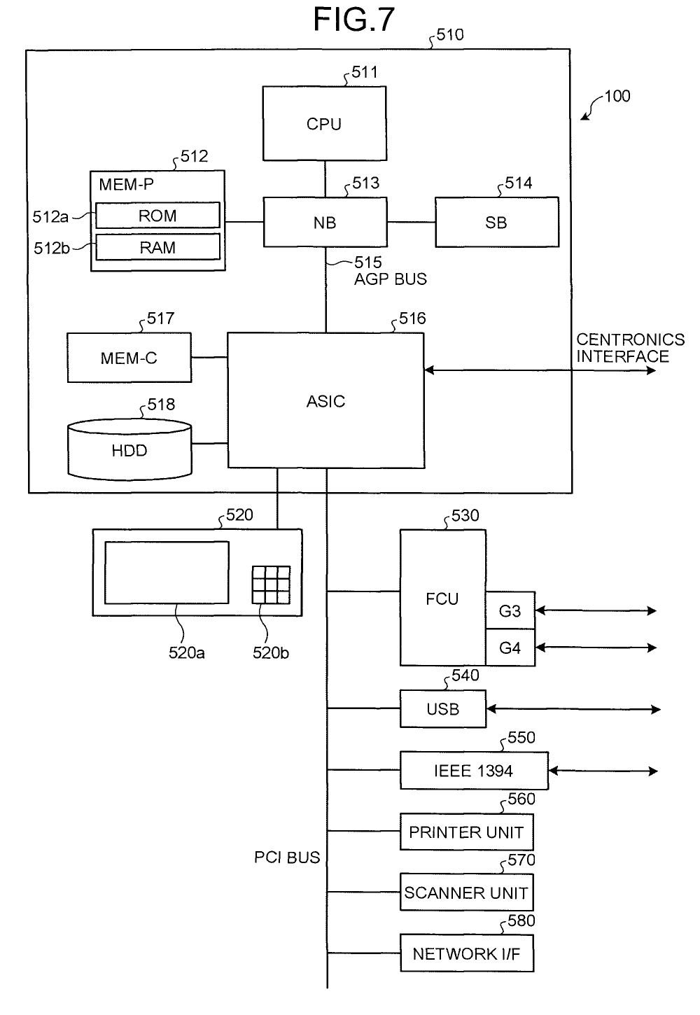

A hardware configuration of the MFP 100 is explained next. FIG. 7 is a schematic diagram for explaining a hardware configuration of the MFP 100. As shown in FIG. 7, the MFP 100 includes a controller 510, a printer unit 560, and a scanner unit 570 that are connected to each other by a PCI (Peripheral Component Interconnect) bus. The controller 510 controls the total of the MFP 100, and controls drawing, communication, and an input from an operation unit 520. The printer unit 560 or the scanner unit 570 includes an image processing part such as error diffusion and Gamma conversion. The operation unit 520 includes an operation display unit 520a that displays document image information of a document read by the scanner unit 570, into a liquid crystal display (LCD) and receives an input from an operator via a touch panel, and a keyboard unit 520b that receives a keyboard input from the operator.

The digital MFP 100 can select a document box function, the copy function, the printer function, and facsimile function, by sequentially changing over between these functions, by an application changeover key of the operation unit 520. When the document box function is selected, a document box mode is obtained, and when the copy function is selected, a copy mode is obtained. When a facsimile function is selected, a facsimile mode is obtained.

The controller 510 includes a central processing unit (CPU) 511 as a key unit of a computer, a system memory (MEM-P) 512, a Northbridge (NB) 513, a Southbridge (SB) 514, an application specific integrated circuit (ASIC) 516, a local memory (MEM-C) 517 as a memory unit, and a hard disk drive (HDD) 518 as a memory unit. The NB 513 and the ASIC 516 are connected to each other by an accelerated graphics port (AGP) bus 515. The MEM-P 512 further includes a read only memory (ROM) 512a, and a random access memory (RAM) 512b.

The CPU 511 performs the total control of the digital MFP 100, has a chip set including the NB 513, the MEM-P 512, and the SB 514, and is connected to other device via the chip set.

The NB 513 is a bridge for connecting the CPU 511 with the MEM-P 512, the SB 514, and the AGP bus 515, includes a memory controller that controls a reading and writing to the MEM-P 512, and includes a PCI master, and an AGP,target.

The MEM-P 512 is a system memory used as a memory for storing a program and data, a memory for developing a program and data, and a memory for drawing in the printer, and includes the ROM 512a, and the RAM 512b. The ROM 512a is a read-only memory used as a memory for storing a program and data to control the operation of the CPU 511. The RAM 512b is a writable and readable memory used as a memory for developing a program and data, and a memory for drawing in the printer.

The SB 514 is a bridge for connecting the NB 513 to the PCI device, and a peripheral device. This SB 514 is connected to the NB 513 via the PCI bus. The PCI bus is connected to a network I/F 580 and the like.

The ASIC 516 is an IC (Integrated Circuit) for image processing having an image-processing hardware element, and has a role of a bridge that connects the AGP bus 515, the PCI bus, the HDD 518, and the MEM-C 517 to each other. The ASIC 516 includes a PCI target and an AGP master, an arbiter (ARB) forming a core of the ASIC 516, a memory controller that controls the MEM-C 517, plural (direct memory access controllers (DMACs) which rotate image data by a hardware logic and the like, and a PCI unit that performs data transfer with the printer unit 560 and the scanner unit 570 via the PCI bus. This ASIC 516 is connected with a fax control unit (FCU) 530, a USB 540, and an IEEE 1394 interface 550, via the PCI bus.

The MEM-C 517 is a local memory used as a copy image buffer and a code buffer. The HDD 518 is a storage that stores therein image data, programs for controlling the operation of the CPU 511, font data, and forms.

The AGP bus 515 is a bus interface for a graphics accelerator card proposed to speed up a graphic processing. By making a direct access to the MEM-P 512 at a high throughput, a graphics accelerator card is processed at a high speed.

A computer program executed by the MFP 100 is provided by being incorporated in a ROM or the like in advance. The computer program executed by the MFP 100 can be provided by being recorded in a computer-readable recording medium such as a compact disk (CD)-ROM, a flexible disk (FD), a CD-recordable (CD-R), and a digital versatile disk (DVD) in an installable format or an executable format.

Further, the computer program executed by the MFP 100 can be provided by being stored in a computer connected to a network such as the Internet, and downloaded via the network. The program executed by the MFP 100 can be also provided or distributed via a network such as the Internet.

The computer program executed by the MFP 100 has a module configuration including each unit described above (the NFC unit, the Bluetooth communication unit, the authenticating unit, the usability determining unit, the data processing unit, and the facsimile transmitting-and-receiving unit). As actual hardware, the CPU (processor) executes the program by reading the program from the ROM, thereby loading each unit into the main memory unit, and generating the NFC unit, the Bluetooth communication unit, the authenticating unit, the usability determining unit, the data processing unit, and the facsimile transmitting-and-receiving unit, into the main memory device.

A computer program executed by the portable terminal device 200 is provided by being incorporated in a ROM or the like in advance. The computer program executed by the portable terminal device 200 can be provided by being recorded in a computer-readable recording medium such as a CD-ROM, a flexible disk, a CD-R, and a DVD in an installable format or an executable format.

Further, the computer program executed by the portable terminal device 200 can be provided by being stored in a computer connected to a network such as the Internet, and downloaded via the network. The program executed by the portable terminal device 200 can be also provided or distributed via a network such as the Internet.

The computer program executed by the portable terminal device 200 has a module configuration including each unit described above (the NFC unit, the Bluetooth communication unit, or the like). As actual hardware, the CPU (processor) executes the program by reading the program from the ROM, thereby loading each unit into the main memory unit, and generating the NFC unit, the Bluetooth communication unit or the like into the main memory device.

While the MFP has been explained in the first embodiment as an example, the present invention is not limited thereto. In other words, the first embodiment can be applied to various apparatuses that include a copy function, FAX function, and printer function.

In the first embodiment, regardless of functions held by the MFP 100, the function setting information set by the portable terminal device 200 is directly transmitted to the MFP 100, and document data is printed. However, the function setting information set by the portable terminal device 200 does not match the MFP 100, in some cases. For example, depending on the specifications of the MFP 100, a printing error occurs. Therefore, function setting information that can be set in the MFP 100 is obtained in the portable terminal device 200 in advance. The user compares the obtained function setting information with the function setting information stored in advance in the portable terminal device, transmits the function setting information that can be set in the MFP, to the MFP, and prints document data. This is explained below.

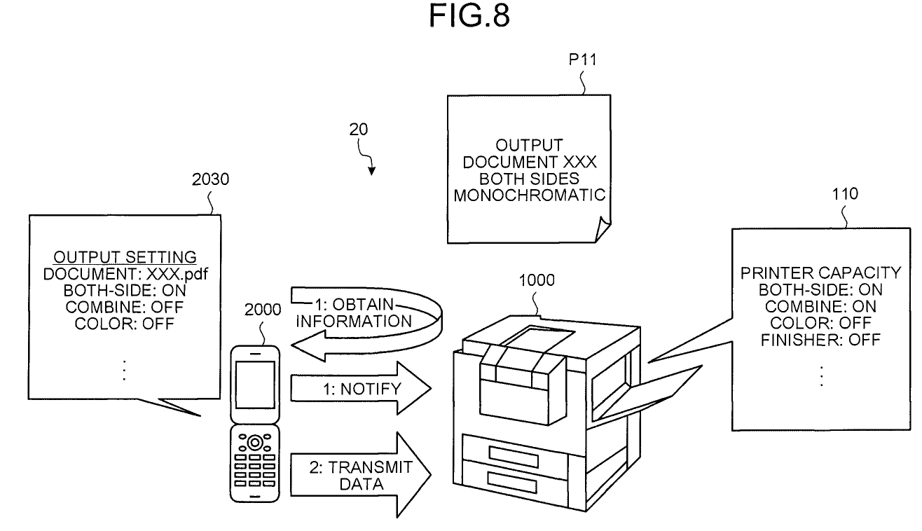

FIG. 8 is a schematic diagram of a configuration of an information processing system 20 according to a second embodiment of the present invention. The information processing system 20 includes an MFP 1000, and a portable terminal device 2000. A method of communication between the MFP 1000 and the portable terminal device 2000, and a relationship between these devices with the network 300, the MFP 400, a facsimile device, and a client terminal device are similar to those according to the first embodiment, and therefore explanations thereof will be omitted. In the example shown in FIG. 8, in the portable terminal device 2000, the user sets “both-side” printing to “on”, sets “combine” to “off”, and sets “color” printing to “on”, for data of document data “XXX.pdf”, as an output setting to the MFP 1000. However, as described later, because only “off” can be set to “color” printing by obtaining a function value of the printer function of the MFP 1000, “color” printing is set to “off”, and this setting information is transmitted. By the printing process explained later, document data P11 shown in FIG. 8 is monochromatic, and a both-side-printed document is output without combining.

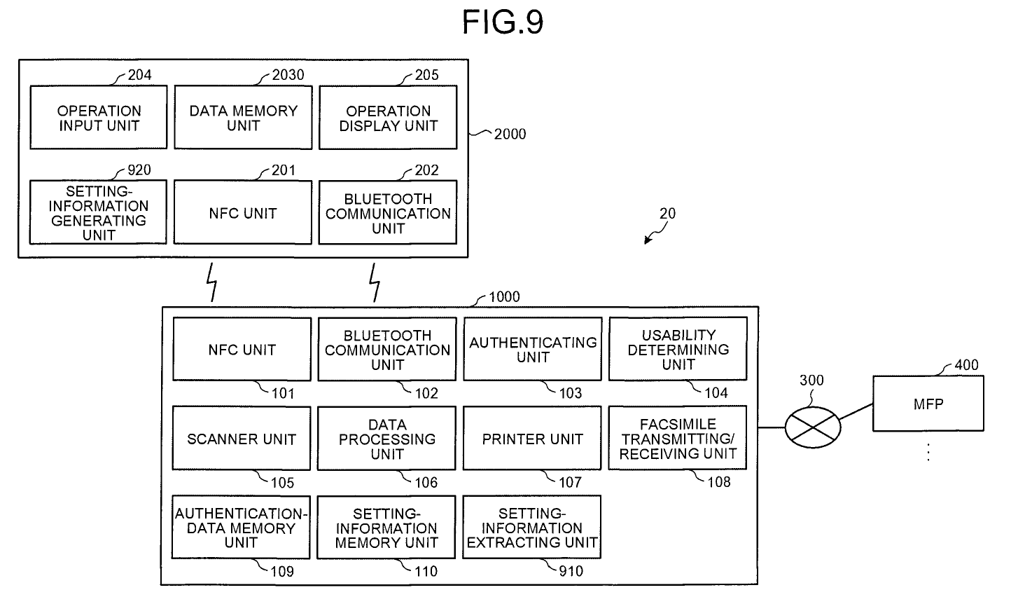

FIG. 9 is a functional block diagram of a configuration of the information processing system 20. The MFP 1000 is different from the MFP 100 of the first embodiment in that the MFP 1000 includes a setting-information extracting unit 910 that transmits function setting information settable to the MFP 1000, to the portable terminal device 2000 via the NFC unit 101. In the following explanations, constituent elements identical with those of the first embodiment are denoted by like reference numerals, and explanations thereof will be omitted.

The portable terminal device 2000 is explained next. The portable terminal device 2000 is different from the portable terminal device 200 of the first embodiment in that the portable terminal device 2000 includes a data memory unit 2030 instead of the data memory unit 203, and that the portable terminal device 2000 includes a setting-information generating unit 920 that generates function setting information settable to the MFP 1000, from function setting information received from the MFP 1000 via the NFC unit 201, and from function setting information stored in the MFP 1000. In the following explanations, constituent elements identical with those of the first embodiment are denoted by like reference numerals, and explanations thereof will be omitted.

The data memory unit 2030 stores therein both the function setting information received from the MFP 1000 via the NFC unit 201, and the function setting information stored in the MFP 1000. The contents of each function setting information are similar to those of the first embodiment, and therefore explanations thereof will be omitted.

The setting-information generating unit 920 generates function setting information within a range settable to the setting-information generating unit 920, corresponding to an input operation that the user performs via the operation input unit 204 (input operation such as “both-side”: “on”, “combine”: “off”, and color: “off”), based on the function setting information received from the MFP 1000 stored in the data memory unit 2030, and the function setting information stored in the MFP 1000.

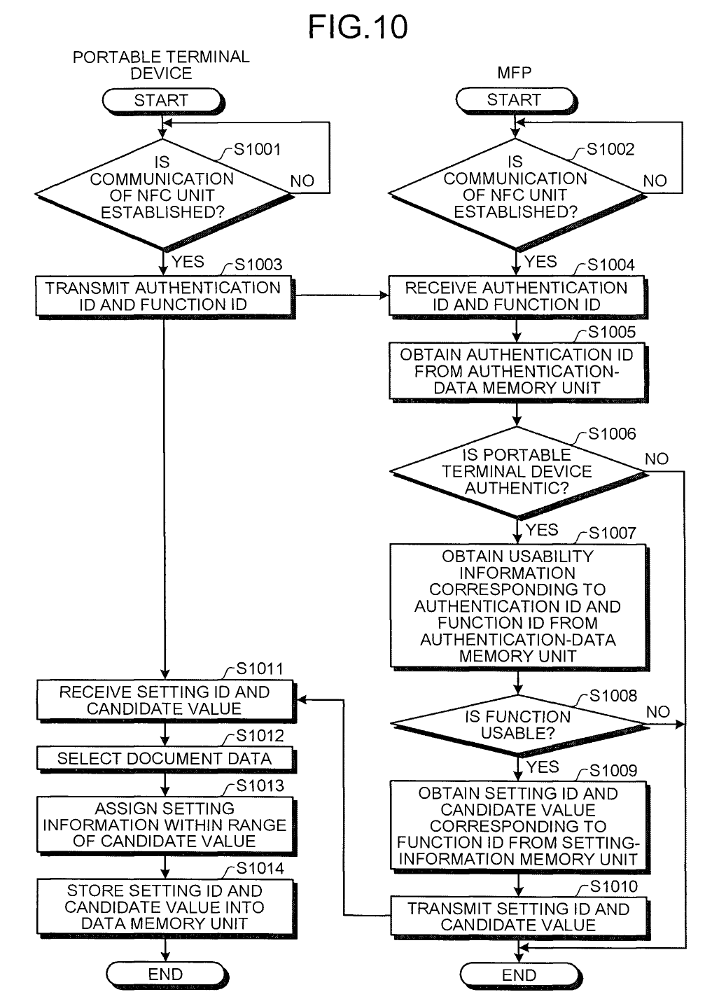

A radio-communication establishment and a setting-candidate-data transmission process performed by the information processing system 20, which includes the MFP 1000 and the portable terminal device 2000 having the above configuration, are explained next. FIG. 10 is a flowchart of a radio-communication-establishment process procedure and a setting-candidate-data-transmission process procedure performed by the information processing system 20.

First, in the portable terminal device 2000, the NFC unit 201 determines whether communication with the NFC unit 101 of the MFP 1000 has been established (step S1001). When it is determined that communication with the NFC unit 101 of the MFP 1000 has not been established, that is, the portable terminal device 2000 is not present within the communication range (NO at step S1001), the process control is returned to step S1001, and this step is repeated until when communication with the NFC unit 101 of the MFP 1000 is established.

Similarly, in the MFP 1000, the NFC unit 101 determines whether communication with the NFC unit 201 of the portable terminal device 2000 has been established (step S1002). When it is determined that communication with the NFC unit 201 of the portable terminal device 2000 has not been established, that is, the portable terminal device 2000 is not present within the communication range (NO at step S1002), the process control is returned to step S1002, and this step is repeated until when communication with the NFC unit 201 of the portable terminal device 2000 is established.

Next, when it is determined that communication with the NFC unit 201 of the portable terminal device 2000 has been established, that is, the portable terminal device 2000 is present within the communication range (YES at step S1001), the NFC unit 201 transmits the authentication ID and the function ID to the NFC unit 101 of the MFP 1000 (step S1003).

When the MFP 1000 determines that communication with the NFC unit 201 of the portable terminal device 2000 has been established, that is, the portable terminal device 2000 is present within the communication range (YES at step S1002), the NFC unit 101 receives the authentication ID and the function ID transmitted from the NFC unit 201 of the portable terminal device 2000 (step S1004). The authenticating unit 103 obtains the authentication ID from the authentication-data memory unit 109 (step S1005). The authenticating unit 103 compares the authentication ID obtained from the authentication-data memory unit 109 with the authentication ID transmitted from the portable terminal device 2000, and determines whether the portable terminal device 2000 is an authentic device (step S1006). When it is determined that the portable terminal device 2000 is not an authentic device, that is, the received authentication ID does not match with an authentication ID stored beforehand in the authentication-data memory unit 109 (NO at step S1006), the process ends.

When it is determined that the portable terminal device 2000 is an authentic device, that is, the received authentication ID matches with an authentication ID stored beforehand in the authentication-data memory unit 109 (YES at step S1006), the MFP 1000 obtains, from the authentication-data memory unit 109, usability information corresponding to the authentication ID and the function ID that the usability determining unit 104 receives from the portable terminal device 2000 (step S1007). The usability determining unit 104 determines whether the assigned function can be used (step S1008). When it is determined that the assigned function cannot be used (NO at step S1008), the process ends.

When it is determined that the assigned function can be used (YES at step S1008), the setting-information extracting unit 910 obtains a setting ID and a candidate value from the setting-information memory unit 110 (step S1009). The NFC unit 101 transmits the setting ID and the candidate value to the portable terminal device 2000 (step (S1010).

In the portable terminal device 2000, the NFC unit 201 receives the setting ID and the candidate value transmitted from the MFP 1000 (step S1011). The operation input unit 204 receives the selection operation of the document data, from the user (step S1012). The setting-information generating unit 920 displays, in the operation display unit 205, the candidate value of the setting ID out of the function setting information stored in advance in the data memory unit 2030, and the setting ID and the candidate value received at step S1011, and receives the setting ID and the candidate value that the user assigns, from the setting ID and the candidate value that are displayed (step S1013). The setting-information generating unit 920 stores the assigned setting ID and the candidate value into the data memory unit 2030 (step S1014).

When the process at step S1014 ends, the user obtains the function setting information of the MFP 1000, confirms the function setting information settable in the MFP 1000 in advance, and ends the process of the setting. After this process, the user performs the process similar to the process of the first embodiment, and can print document data stored in the portable terminal device 2000, from the MFP 1000.

As explained above, when the setting ID and the candidate value corresponding to the function ID are obtained from the portable terminal device 2000 in advance, the user can set the function setting information corresponding to the function held by the used MFP 1000, at the portable terminal device 2000 side. Therefore, the user can set the function information most suitable for printing, from the used MFP, and efficiently perform a desired process to the MFP.

FIG. 8 is an example where the user performs the printing process to the MFP 1000 from the portable terminal device 2000, following the procedures described above. In FIG. 8, the user compares the function setting information obtained from the MFP 1000 with the function setting information stored in advance in the data memory unit 2030. After confirming a difference between the function setting information (for example the function setting information of color: “off” shown by an outline in FIG. 8), the user can set both-side printing: “on”, combine: “off”, and color: “off” to the data memory unit 2030 of the portable terminal device 2000 as the function setting information, and can print the monochromatic document P11 on both sides, from the MFP 1000.

A third embodiment of the present invention is explained below with reference to the accompanying drawing. In the third embodiment, configurations and functions of a multi function peripheral and a portable terminal device are applied to a car navigation system.

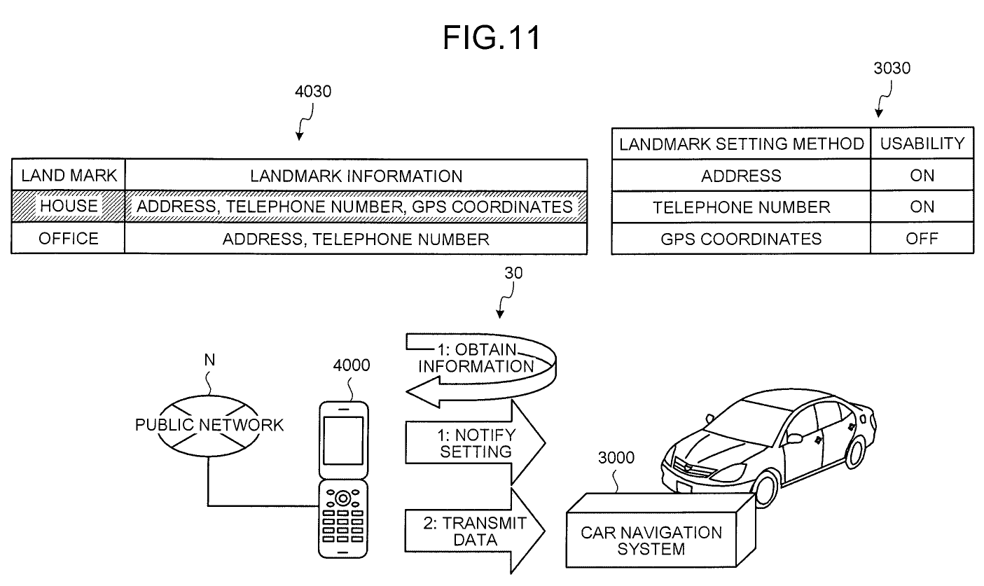

FIG. 11 is a schematic diagram of a configuration of a car navigation system 30 according to the third embodiment. The car navigation system 30 includes a car navigation system 3000 and a portable terminal device 4000. The car navigation system 3000 and the portable terminal device 4000 can communicate with each other using two communication units in the manner explained in the first and second embodiments.

First, the portable terminal device 4000 is explained. The portable terminal device 4000 is different from the portable terminal devices 200 and 2000 according to the first and second devices in that the portable terminal device 4000 includes a data memory unit 4030, instead of the data memory unit 203 in the first embodiment and the data memory unit 2030 in the second embodiment. The portable terminal device 4000 is connected to a public line N such as a telephone line, and can also communicate with other portable terminal device via the public line N.

The portable terminal device 4000 obtains in advance, destination information (for example, an address, a telephone number, global positioning system (GPS) coordinates, or the like) that can be set by the car navigation system 3000, via the NFC unit. The user compares the obtained destination information with destination information of position information of home stored in the data memory unit 4030. The user sets destination information that the car navigation system 3000 can set, and transmits the destination information to the car navigation system 3000 via the NFC unit, and also transmits map information stored in the portable terminal device 4000, to the portable terminal device 4000, via the Bluetooth communication unit.

On the other hand, the car navigation system 3000 obtains route information from the current-position information and the destination information transmitted from the car navigation system 3000, via the NFC unit, obtains the map information via the Bluetooth communication unit, and specifies the current position of the car navigation system 3000, on the earth, using a satellite position-measuring system. The car navigation system 3000 displays, in a display (not shown) of the car navigation system 3000, a route to the destination and traffic congestion information, based on the current-position information, the route information, and the destination information. In this case, the Bluetooth communication can be performed in a relatively wide range as described above. Therefore, communication can be performed even when the user is at the rear seat of the vehicle.

While explanations of other processes referring to a flowchart are omitted, like the MFP 100 and the MFP 1000 in the first and second embodiments, the portable terminal device 4000 establishes communication between the car navigation system 3000 and the NFC unit. The NFC unit transmits the authentication ID, the function ID, and landmark information corresponding to the print setting information. The car navigation system 3000 searches the route after authenticating these. The car navigation system 3000 authenticates these, and searches the route. For the landmark information, the user can obtain setting information (for example, an address and a telephone number of a destination) settable by the car navigation system 300, by communicating with the NFC unit in advance, and the route search process can be performed in a process similar to that of the procedures in the first or second embodiment.

A fourth embodiment of the present invention is explained below with reference to the accompanying drawing. In the fourth embodiment, configurations and functions of the multi function peripheral and the portable terminal device described above are applied to a slideshow system.

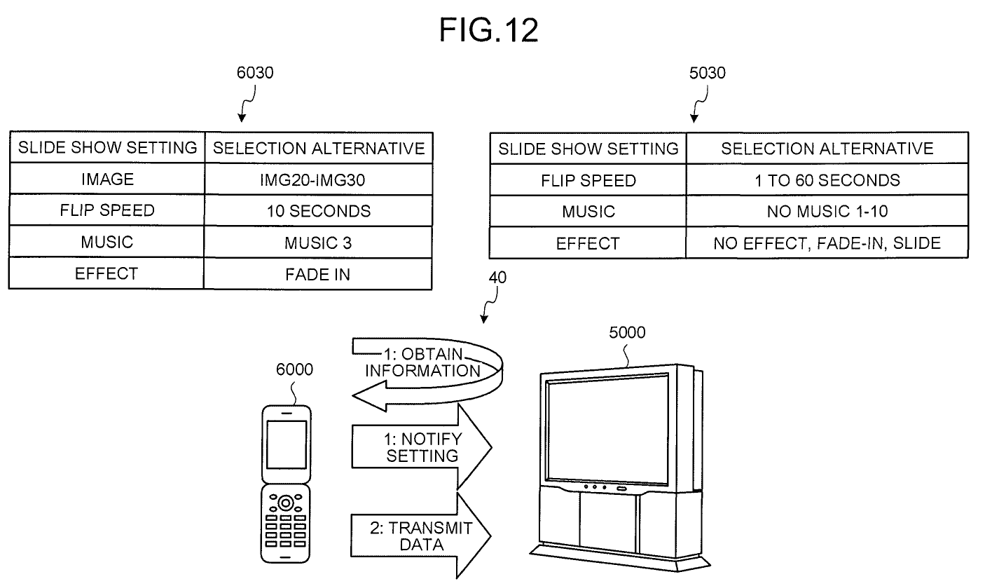

FIG. 12 is a schematic diagram of a configuration of a slideshow system 40 according to the fourth embodiment. The slideshow system 40 includes an information appliance 5000, and a portable terminal device 6000. The information appliance 5000 and the portable terminal device 6000 can communicate with each other using two communication units like in the first and second embodiments.

First, the portable terminal device 6000 is explained. The portable terminal device 6000 is different from those in the first and second embodiments in that the portable terminal device 6000 includes a data memory unit 6030, instead of the data memory unit 203 in the first embodiment and the data memory unit 2030 in the second embodiment.

The portable terminal device 6000 obtains in advance, setting values (for example, setting information of flip speed of slides, music, and effect) that the information appliance 5000 can set, via the NFC unit. The user compares the obtained setting value with the setting value stored in the data memory unit 6030, sets a setting value that the information appliance 5000 can set, and transmits the setting value to the information appliance 5000 via the NFC unit. The user also transmits photograph data stored in the portable terminal device 6000, to the information appliance 5000 via the Bluetooth communication unit.

On the other hand, the information appliance 5000 obtains the setting value transmitted from the portable terminal device 6000, via the NFC unit, and obtains the photograph data via the Bluetooth communication unit. The user brings the portable terminal device 6000 to the information appliance 5000 again, thereby starting a slideshow. In the example shown in FIG. 12, photograph data in the range of “image: IMG20-IMG20” is assigned, and a setting value of a ten-second “flip speed” is assigned. The user can view the slideshow in the range in which the information appliance 5000 can be set, while holding the portable terminal device 6000 at hand.

While explanations of other processes referring to a flowchart are omitted, like the MFP 100 and the MFP 1000 in the first and second embodiments, the portable terminal device 4000 establishes communication between the information appliance and the NFC unit. The NFC unit transmits the authentication ID, the function ID, and slideshow setting values corresponding to the print setting information. The car navigation system 3000 searches the route after authenticating these. The information appliance 5000 authenticates these, and starts the slideshow. For the slideshow setting values, the user can obtain setting information (for example, flip speed, music, and effect) that the information appliance 5000 can set, by communicating with the NFC unit in advance, and the setting of the slideshow can be performed in a process similar to that of the procedures in the first or second embodiment.

In the first or second embodiment, after the function setting information stored in the portable terminal device is communicated with the MFP via the NFC unit, document data is automatically transmitted via the Bluetooth communication unit. The document data is printed following the function setting information transmitted in advance. However, depending on users, the function setting information set by the users is wrong, and unintended function setting information can be transmitted. In this case, an interval is necessary between the end of transmission of the function setting information and the start of transmitting the document data. Therefore, it is explained below a manual changeover between the obtaining of function setting information via the NFC unit (hereinafter, “function-information setting mode”) and the transmission of document data via the Bluetooth communication unit (hereinafter, “entity-information communication mode”).

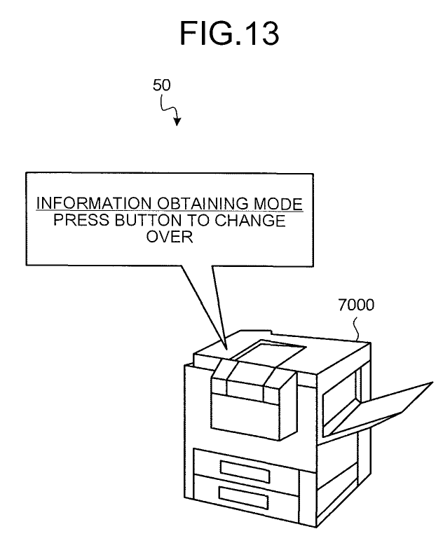

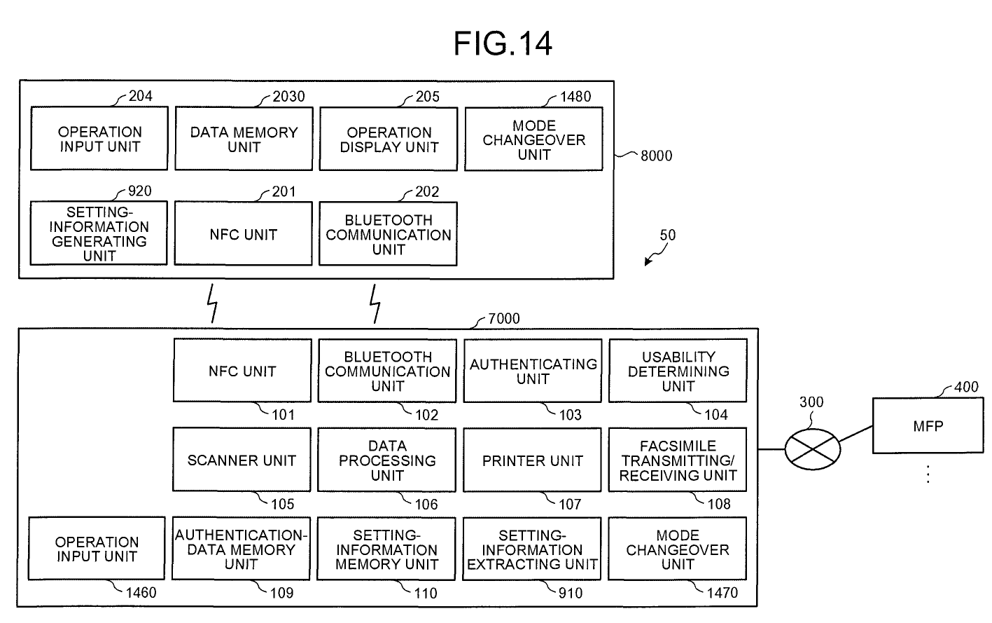

FIG. 13 is a schematic diagram of a configuration of an information processing system 50 according to a fifth embodiment of the present invention. The information processing system 50 includes an MFP 7000 and a portable terminal device 8000 (refer FIG. 14). A communication method between the MFP 7000 and the portable terminal device 8000, and a relationship between the network 300, the other MFP 400, the facsimile device, and the client terminal device are similar to those in the first embodiment, and therefore explanations thereof will be omitted.

FIG. 14 is a block diagram of a configuration of the information processing system 50. The MFP 7000 is different from the MFPs according to the first and second embodiments in that the MFP 7000 includes an operation input unit 1460 that receives the input operation from the user, and a mode changeover unit 1470 that changes over between the function-information setting mode and the entity-information communication mode. In the following explanations, constituent elements identical with those in the first embodiment are denoted by like reference numerals, and explanations thereof will be omitted.

Further, the portable terminal device 8000 is different from that of the portable terminal device in the first or second embodiment in that the portable terminal device 8000 includes a mode changeover unit 1480 that changes over between the function-information setting mode and the entity-information communication mode. In the following explanations, like the example of the MFP, constituent elements identical with those in the first embodiment are denoted by like reference numerals, and explanations thereof will be omitted.

The operation input unit 1460 includes an operation button such as a push button, and receives the input of a changeover operation between the function-information setting mode and the entity-information communication mode from the user. For example, the function-information setting mode and the entity-information communication mode are changed over by pressing the operation button.

Upon receiving a changeover operation from the operation input unit 1460, the mode changeover unit 1470 changes over between the function-information setting mode and the entity-information communication mode. For example, when the MFP 7000 is already in the function-information setting mode, the mode changeover unit 1470 changes this mode to the entity-information communication mode. When the MFP 7000 is already in the entity-information communication mode, the mode changeover unit 1470 changes this mode to the function-information setting mode.

Upon receiving a changeover operation from the operation input unit 204, the mode changeover unit 1480 changes over between the function-information setting mode and the entity-information communication mode. For example, when the portable terminal device 8000 is already in the function-information setting mode, the mode changeover unit 1480 changes this mode to the entity-information communication mode. When the portable terminal device 8000 is already in the entity-information communication mode, the mode changeover unit 1480 changes this mode to the function-information setting mode.

As explained above, both the MFP 7000 and the portable terminal device 8000 can prevent the user from printing document data by a wrong unintended setting. Because the operation input unit 1460 changes over between the function-information setting mode and the entity-information communication mode, the user can easily naturally determine which one of the process of obtaining the function information and a desired process is being performed.

While explanations of other processes referring to a flowchart are omitted, the MFP 7000 is different from the MFP 100 according to the first embodiment and the MFP 1000 according to the second embodiment in that the user selects in advance the mode of obtaining print setting information or the mode of communicating entity data. The portable terminal device 8000 and the MFP 7000 establish communication by the NFC unit, the NFC unit transmits the authentication ID, the function ID, and the print setting information, the information appliance 5000 authenticates these, and performs the printing process, in a procedure similar to the process procedures of the first and second embodiments.

In the fifth embodiment, the function-information setting mode of obtaining the function setting information via the NFC unit and the entity-information communication mode of transmitting data such as document via the Bluetooth communication unit are manually changed over using the operation input unit at one position. However, users sometimes press the operation input unit by error, and change over between the function-information setting mode and the entity-information communication mode, by error. Therefore, a changeover between the function-information setting mode and the entity-information communication mode by providing the operation input unit at a different position in the MFP is explained below.

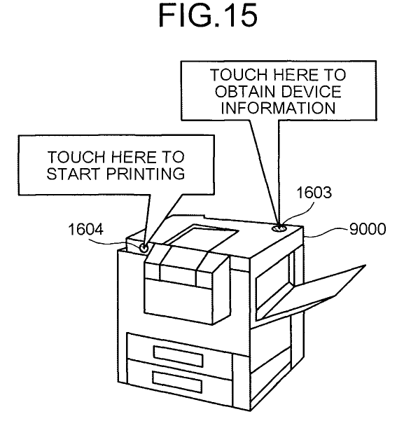

FIG. 15 is a schematic diagram of a configuration of an information processing system 60 according to a sixth embodiment of the present invention. The information processing system 60 includes an MFP 9000 and the portable terminal device 8000 (not shown). A configuration of the portable terminal device 8000, and a communication method between the MFP 9000 and the portable terminal device 8000 are similar to those in the fifth embodiment, and therefore explanations thereof will be omitted.

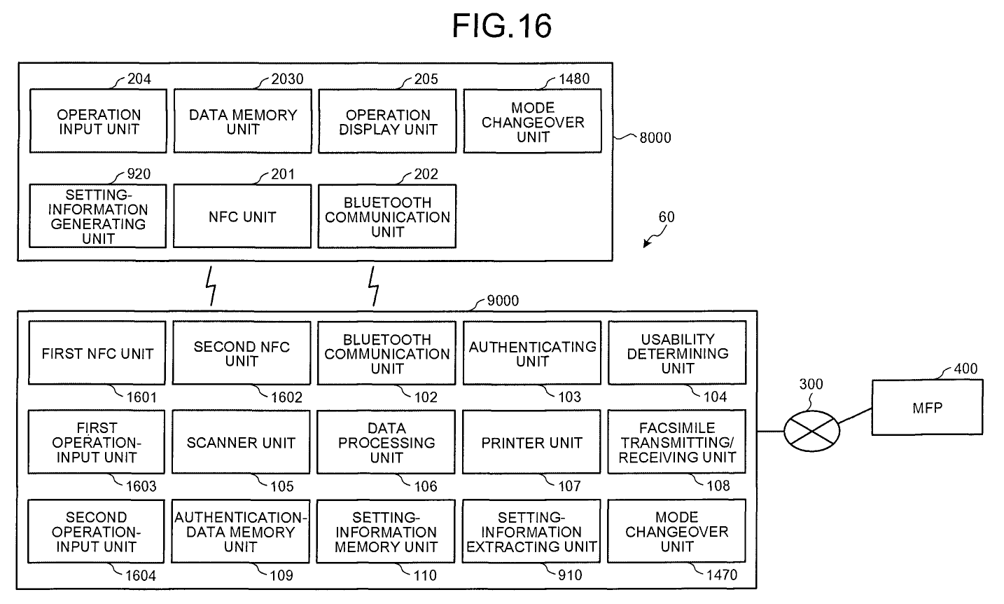

FIG. 16 is a functional block diagram of a configuration of the information processing system 60. The MFP 9000 is different from the MFP according to the fifth embodiment in that the MFP 9000 includes a first operation-input unit 1603 that receives the input operation of the function-information communication mode from the user, a second operation-input unit 1604 that receives the input operation of the entity-information communication mode from the user, a first NFC unit 1601 that communicates with the portable terminal device 8000 in response to the input operation from the first operation-input unit 1603, and a second NFC unit 162 that communicates with the portable terminal device 8000 in response to the input operation from the second operation-input unit 1604. In the following explanations, constituent elements identical with those in the fifth embodiment are denoted by like reference numerals, and explanations thereof will be omitted.

The first operation-input unit 1603 includes an operation panel such as a touch panel. The portable terminal device 8000 establishes communication with the NFC unit 201 of the portable terminal device 8000. When a communication distance becomes short, that is, when the communication distance becomes zero to ten-odd millimeters, the portable terminal device 8000 performs radio communication with the NFC unit 201 of the portable terminal device 8000 in non-contact, via the first NFC unit 1601. When the portable terminal device 8000 establishes communication with the first operation-input unit 1603, the mode changeover unit 1470 changes the mode to the function-information setting mode.

The second operation-input unit 1604 includes an operation panel such as a touch panel. The portable terminal device 8000 establishes communication with the NFC unit 201 of the portable terminal device 8000. When a communication distance becomes short, that is, when the communication distance becomes zero to ten-odd millimeters, the portable terminal device 8000 performs radio communication with the NFC unit 201 of the portable terminal device 8000 in non-contact, via the second NFC unit 1602. When the portable terminal device 8000 establishes communication with the first operation-input unit 1603, the mode changeover unit 1470 changes the mode to the entity-information setting mode.

As explained above, in the MFP 9000, the user can naturally determine to which position the portable terminal device should be brought close, to perform the process of obtaining function information, or a desired process.

While the first to sixth embodiments of the present invention have been explained above, various modifications and improvements can be added to the embodiments. In addition, the configurations and functions explained in the first to sixth embodiments can be freely combined with each other.

According to an aspect of the present invention, the user can naturally assign a device, set function information concerning the assigned device, and perform a desired process to the device.

According to another aspect of the present invention, the user can naturally assign a device, set optimum function information by obtaining in advance function information concerning the assigned device, and efficiently perform a desired process to the device.

According to still another aspect of the present invention, the user can perform a desired process by assigning in detail function information of the image forming apparatus.

According to still another aspect of the present invention, the user can avoid performing wrong processes by an unintended setting.

According to still another aspect of the present invention, the user can naturally determine which one of the process of obtaining function information and the process of performing a desired process is being performed.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing system comprising a portable terminal device including a first communication unit and a second communication unit of mutually different communication ranges, and an information processing device including a third communication unit having the same communication method as that of the first communication unit and a fourth communication unit having the same communication method as that of the second communication unit, the portable terminal device and the information processing unit communicating with each other in non-contact communication using the first communication unit and the third communication unit, and the portable terminal device and the information processing unit communicating with each other in non-contact communication using the second communication unit and the fourth communication unit, wherein
the portable terminal device includes
a first communication control unit that transmits communication setting information to establish communication between the second communication unit and the fourth communication unit, and first function information showing a process to predetermined information to be received or transmitted by the second communication unit, to the information processing device in non-contact communication via the first communication unit, when the portable terminal device approaches a communication range of the information processing device;
an input receiving unit that receives an input of the communication setting information and the first function information; and
a second communication control unit that establishes communication with the information processing device, and transmits predetermined information to the information processing device or receives predetermined information from the information processing device, in non-contact communication via the second communication unit, and
the information processing device includes
a third communication control unit that receives the communication setting information and the first function information from the portable terminal device in non-contact, via the third communication unit, when the portable terminal device approaches the communication range of the information processing device;
a fourth communication control unit that establishes communication with the portable terminal device based on the communication setting information received by the third communication control unit, and receives predetermined information from the portable terminal device or transmits predetermined information to the portable terminal device in non-contact communication; and
a processing unit that processes the predetermined information corresponding to the first function information received by the fourth communication control unit.

2. The information processing system according to claim 1, wherein
the information processing device further includes a memory unit that stores therein second function information showing that the predetermined information can be processed,
the portable terminal device further includes a generating unit that generates third function information based on the second function information and the first function information received by the input receiving unit, and
the first communication control unit transmits the generated third function information to the information processing device in non-contact communication via the first communication unit.

3. The information processing system according to claim 2, wherein the first function information, the second function information, and the third function information include at least one of an entity name of the predetermined information, a page range, color information, print information, necessity of combining, necessity of sorting, necessity of punching, and necessity of stapling.

4. The information processing system according to claim 1, wherein the third communication control unit changes over between a function-information setting mode as an operation of transmitting communication setting information to establish communication between the second communication unit and the fourth communication unit and function information showing a process to predetermined information to be received or transmitted by the second communication unit, and an entity-information communication mode as an operation of transmitting predetermined information to the information processing device or receiving predetermined information from the information processing device in non-contact communication via the second communication unit.

5. The information processing system according to claim 4, wherein
the information processing device further includes a changeover-input receiving unit that receives communication by the third communication control unit which receives the communication setting information and the first function information from the portable terminal device in non-contact communication via the third communication unit, or communication by the fourth communication control unit that receives the predetermined information from the portable terminal system or transmits the predetermined information to the portable terminal system in non-contact communication, and
the third communication control unit changes over between the function-information setting mode and the entity-information communication mode via the third communication unit, based on an instruction from the changeover-input receiving unit.

6. The information processing system according to claim 5, wherein
the information processing device includes a plurality of the third communication units, a plurality of the third communication control units, and a plurality of the changeover-input receiving units,
one of the third communication control units sets the function-information setting mode via the third communication unit, based on an instruction from one of the changeover-input receiving unit, and
rest of the third communication control units set the entity-information communication mode via the third communication unit, based on an instruction from rest of the changeover-input receiving units.

7. An information processing device comprising a first communication unit and a second communication unit that communicate with a portable terminal device in non-contact communication, and have mutually different communication ranges, the information processing unit further comprising:
a first communication control unit that receives from the portable terminal device in non-contact communication, communication setting information to establish communication of the second communication unit and function information showing a function to process predetermined information to be received or transmitted by the second communication unit, when the portable terminal device approaches a communication range of the information processing device;
a second communication control unit that establishes communication with the portable terminal device based on the communication setting information received by the first communication control unit, and that receives predetermined information from the portable terminal device or transmits predetermined information to the portable terminal device in non-contact communication; and
a processing unit that processes the predetermined information by function corresponding to the function information received by the second communication control unit.

8. The information processing device according to claim 7, wherein the function information include at least one of an entity name of the predetermined information, a page range, color information, print information, necessity of combining, necessity of sorting, necessity of punching, and necessity of stapling.

9. The information processing device according to claim 7, wherein the first communication control unit changes over between a function-information setting mode as an operation of transmitting the communication setting information and function information showing a process of predetermined information received or transmitted by the second communication unit, and an entity-information communication mode as an operation of transmitting predetermined information to the information processing device or receiving predetermined information from the information processing device in non-contact communication via the second communication unit.

10. The information processing device according to claim 9, further comprising a changeover-input receiving unit that receives communication by the first communication control unit which receives the communication setting information and the function information from the portable terminal device in non-contact communication via the first communication unit, or communication by the second communication control unit that receives the predetermined information from the portable terminal system or transmits the predetermined information to the portable terminal system in non-contact communication, wherein
the first communication control unit changes over between the function-information setting mode and the entity-information communication mode via the first communication unit, based on an instruction from the changeover-input receiving unit.

11. The information processing device according to claim 10, further comprising a plurality of the first communication units, a plurality of the first communication control units, and a plurality of the changeover-input receiving units,
one of the first communication control units sets the function-information setting mode via the first communication unit, based on an instruction from one of-the changeover-input receiving units, and
rest of the first communication control units set the entity-information communication mode via the first communication unit, based on an instruction from rest of the changeover-input receiving units.

12. An information processing method realized on an information processing device comprising a first communication unit and a second communication unit that communicate with a portable terminal device in non-contact communication, and have mutually different communication ranges, the information processing method comprising:
performing first communication control including receiving from the portable terminal device in non-contact communication, communication setting information to establish communication of the second communication unit and function information showing a function to process predetermined information to be received or transmitted by the second communication unit, when the portable terminal device approaches a communication range of the information processing device;
performing second communication control including establishing communication with the portable terminal device based on the communication setting information received at the performing first communication control, and receiving predetermined information from the portable terminal device or transmitting predetermined information to the portable terminal device in non-contact communication; and
processing the predetermined information by function corresponding to the function information received at the performing second communication control.

13. The information processing method according to claim 12, wherein the function information include at least one of an entity name of the predetermined information, a page range, color information, print information, necessity of combining, necessity of sorting, necessity of punching, and necessity of stapling.

14. The information processing method according to claim 12, wherein the performing first communication control includes changing over between a function-information setting mode as an operation of transmitting the communication setting information and function information showing a process of predetermined information received or transmitted by the second communication unit, and an entity-information communication mode as an operation of transmitting predetermined information to the information processing device or receiving predetermined information from the information processing device in non-contact communication via the second communication unit.

15. The information processing method according to claim 14, further comprising receiving input of communication by the performing first communication control, which includes receiving the communication setting information and the function information from the portable terminal device in non-contact communication via the first communication unit, or by the performing second communication control, which includes receiving the predetermined information from the portable terminal system or transmits the predetermined information to the portable terminal system in non-contact communication, wherein
the performing first communication control includes changing over between the function-information setting mode and the entity-information communication mode via the first communication unit, based on an instruction from the receiving.

16. The information processing method according to claim 15, further comprising a plurality of the first communication units, a plurality of the performing first communication control units, and a plurality of the receiving,
one of the performing first communication control includes setting the function-information setting mode via the first communication unit, based on an instruction from one of the receiving, and
rest of the performing first communication control includes setting the entity-information communication mode via the first communication unit, based on an instruction from rest of the receiving.
